(19) United States
(12) Patent Application Publication
(10) Pub. No.: US 2011/0308065 A1
(43) Pub. Date: Dec. 22, 2011

(54) CAPTIVE SCREW INSTALLATION METHOD

(76) Inventor: Kuo-Chung WANG, Yunlin County (TW)

(21) Appl. No.: 12/817,668

(22) Filed: Jun. 17, 2010

(51) Int. Cl. B23P 17/00

(52) U.S. Cl. 29/527.2

(57) ABSTRACT

A captive screw installation method includes the step of riveting a barrel to a panel frame, the step of coating a coating on the surface the barrel and the surface of the panel frame, the step of fastening a lock screw to a plastic knob and a spring member to the locks crew, the step of inserting the lock screw and the spring member into the barrel and then coupling the knob to the barrel. The barrel of the captive screw is riveted to the panel frame prior to coating, avoiding damage to the coating during installation.

### BACKGROUND OF THE INVENTION

1. Field of the Invention

The present invention relates to the application of a captive screw for joining two metal panel frames and more particularly, to a captive screw installation method, which has the barrel of the captive screw be riveted to a panel frame prior to coating, avoiding damage to the coating during installation.

2. Description of the Related Art

When fastening panel frames together, for example, when fastening an attached piece to a parent or mother board, a positioning screw formed of a knob, a ring and a screw nail is usually used. During installation, the screw nail and the ring are secured to the mother panel frame, and then the knob is rotated to drive the screw nail into the attached panel frame, and then a hand tool is used to fasten tight the screw nail, affixing the first and attached panel frames together. This panel frame joining method can be used in a machine tool, industrial computer or other places to join panel frames together. In a machine tool, the location where an attached piece is to be affixed to the parent or mother board corresponds to the power drive or speed-adjustment unit inside the housing. Detachable panel frame mounting facilitates examination and repair of the power drive or speed-adjustment unit. However, when dismounting the attached piece from the parent or mother board, the fastening screws may be lost, affecting re-installation and causing trouble.

To facilitate detachable installation, captive screws are developed. Captive screws are screws specially designed to lock into place on a mother panel frame, enabling the easy installation and removal of an attached panel frame without release of the screws. Regular captive screws are commonly formed of a knob, a lock screw and a mounting barrel. During application of a captive screw, the mounting barrel of the captive screw is fastened to a mounting through hole on the mother panel frame, and then the lock screw is driven into the attached panel frame to lock the attached panel frame to the mother panel frame. When the lock screw is unfastened from the attached panel frame and the attached panel frame is removed from the mother panel frame, the captive screw is still kept attached to the mother panel frame. According to the conventional design, the knob may be made of metal and then fastened to the lock screw. Alternatively, the knob can be directly molded from plastics on the head of the lock screw. Further, the mounting barrel is fastened to the mother panel frame by riveting.

Further, a panel frame may be coated with a color coating for causing a sense of beauty. The coating is done prior to riveting of the mounting barrel of a captive screw to the panel frame. When riveting the mounting barrel to the panel frame, the coating may be damaged. If the coating operation is performed after installation of the captive screw, a shield shall be used to shield the captive screw. After coating, the shield must be removed from the captive screw, slowing down the fabrication and increasing the manufacturing cost. Further, the coating must be backed to a dry status. During backing, the plastic knob may be caused to deteriorate or fade, or may be softened, fused or burned, and the spring member may receive elastic fatigue damage, lowering the structural strength. If a metal knob is used to substitute for a plastic knob, the coating may be damaged by the knob during installation.

Therefore, it is desirable to provide a captive screw installation method that eliminates the aforesaid problems.

### SUMMARY OF THE INVENTION

The present invention has been accomplished under the circumstances in view. It is therefore an object of the present invention to provide a captive screw installation method, which facilitates captive screw installation, avoiding damage to the coating or damage to the component parts, and saving much installation labor and time.

According to one aspect of the present invention, the barrel of the prepared captive screw is riveted to a mounting through hole of a panel frame prior to coating of a coating on the surface of the barrel and the surface of the panel frame, avoiding damage to the coating during installation.

Further, after installation of the barrel in the panel frame 5, the other component parts, i.e., the lock screw, plastic knob and spring member of the captive screw are assembled and then coupled to the barrel, avoiding elastic fatigue of the spring member due to tempering, or property deterioration, softening, fading or fusion of the plastic knob due to heat.

Further, the elastically deformable material property of the plastic knob facilitates detachable installation of the plastic knob in the barrel without any tools, and avoids damage to the coating during sliding movement of the knob along the barrel.

Further, it is not necessary to shield the barrel when coating the barrel and the panel frame, or to remove the barrel from the panel frame after the coating operation is done, and therefore the captive screw installation procedure is simplified.

### BRIEF DESCRIPTION OF THE DRAWINGS

FIG. 1 is an elevational view of a captive screw in accordance with the present invention.

FIG. 2 is an exploded view of the captive screw in accordance with the present invention.

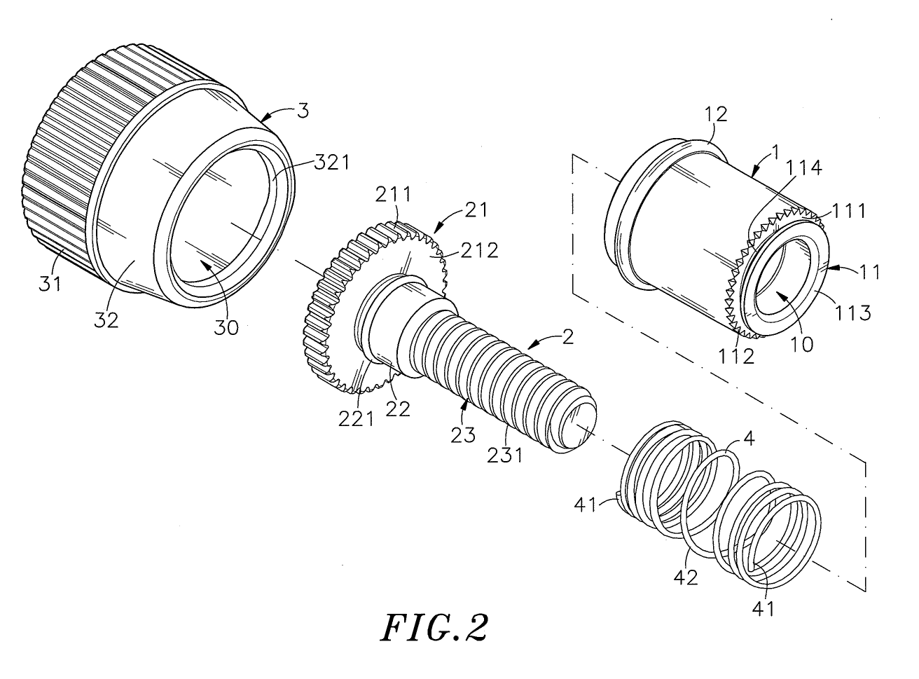

FIG. 3 is a sectional side view, showing the barrel aimed at the mounting through hole of the mother panel frame according to the present invention.

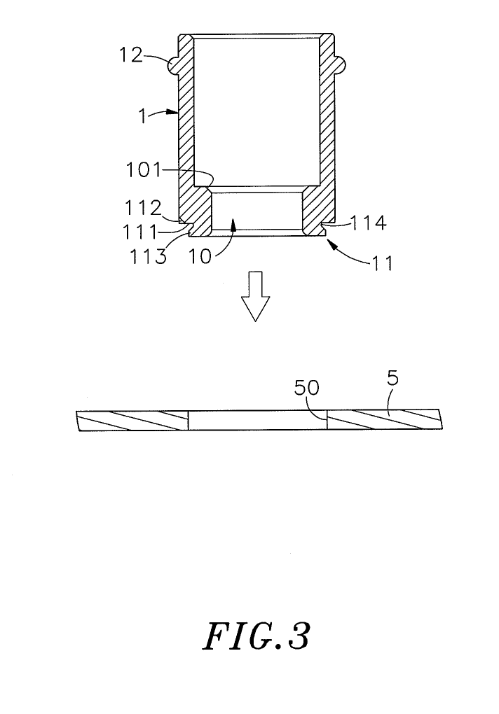

FIG. 4 is a schematic sectional side view, showing the performance of a spray painting operation after installation of the barrel in the mother panel frame according to the present invention.

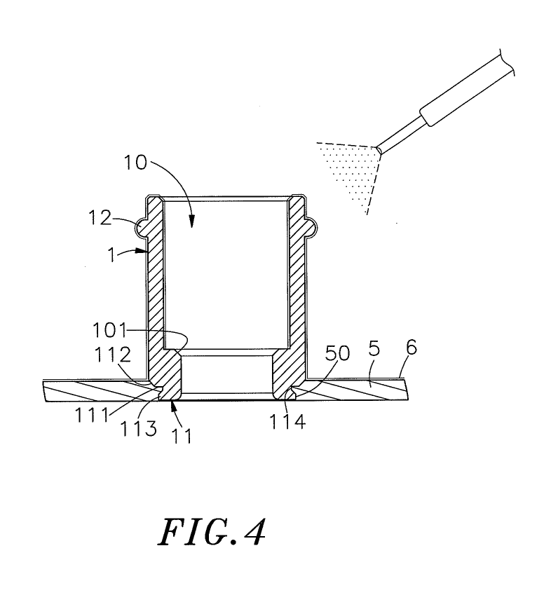

FIG. 5 is a schematic sectional view, showing the knob, the lock screw and the spring member assembled and aimed at the barrel at the mother panel frame according to the present invention.

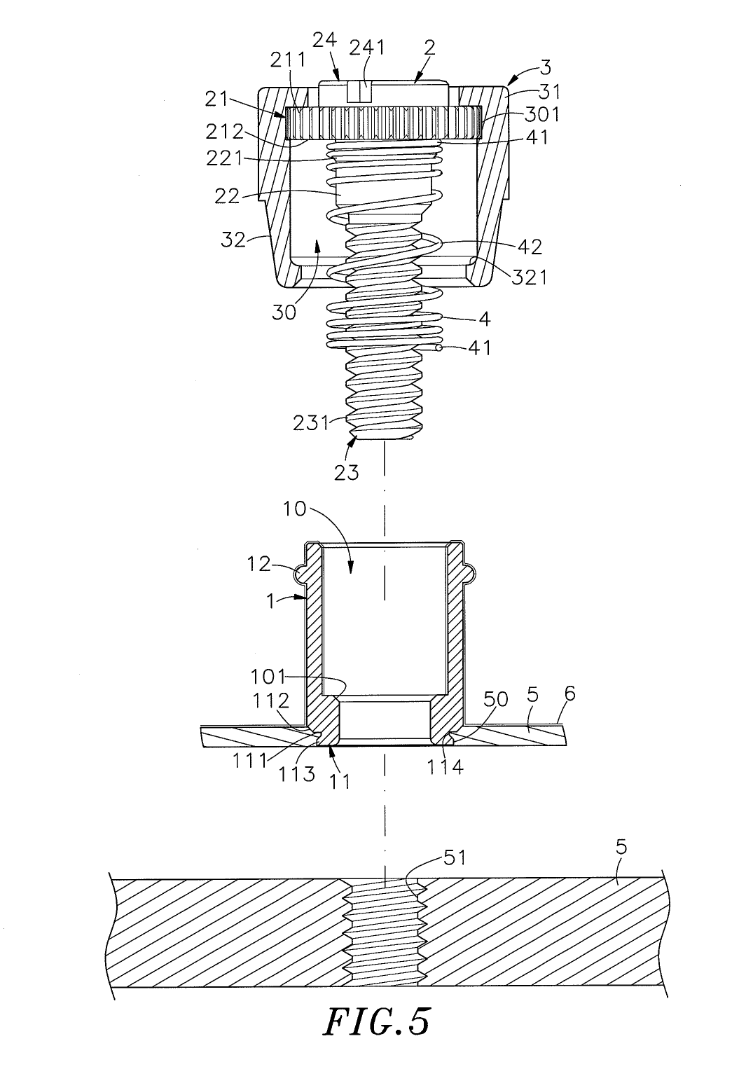

FIG. 6 corresponds to FIG. 5, showing the captive screw installed in the mother panel frame before fixation to the attached panel frame.

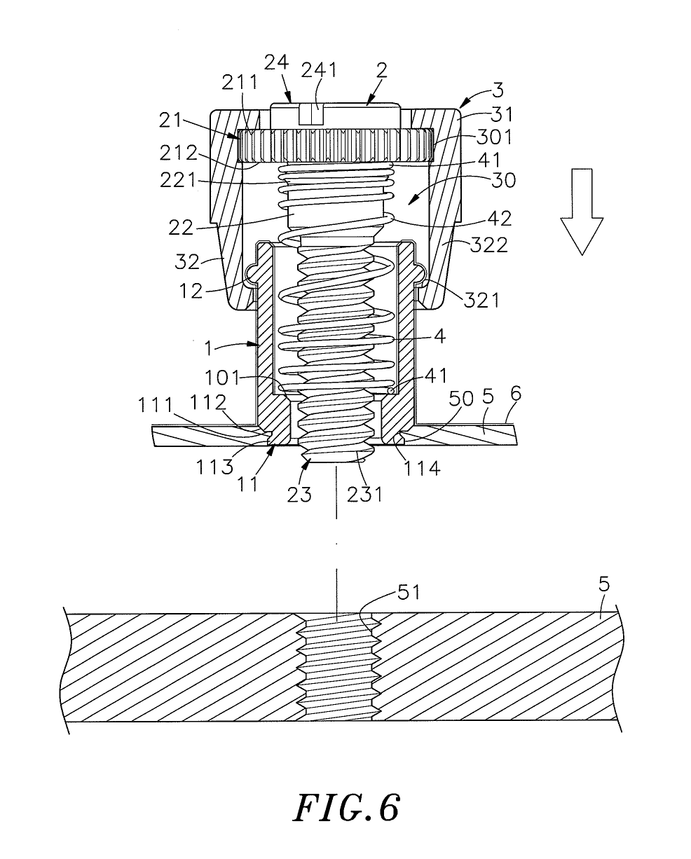

FIG. 7 corresponds to FIG. 6, showing the lock screw of the captive screw fastened to the attached panel frame.

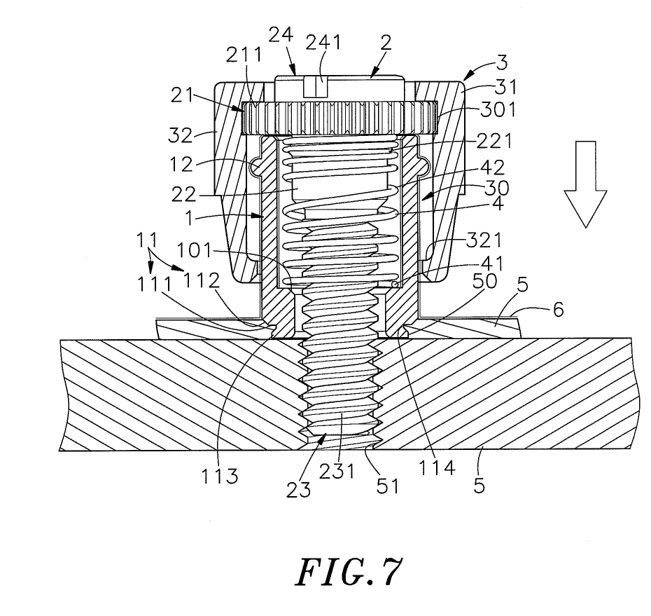

FIG. 8 is a captive screw installation flow in accordance with the present invention.

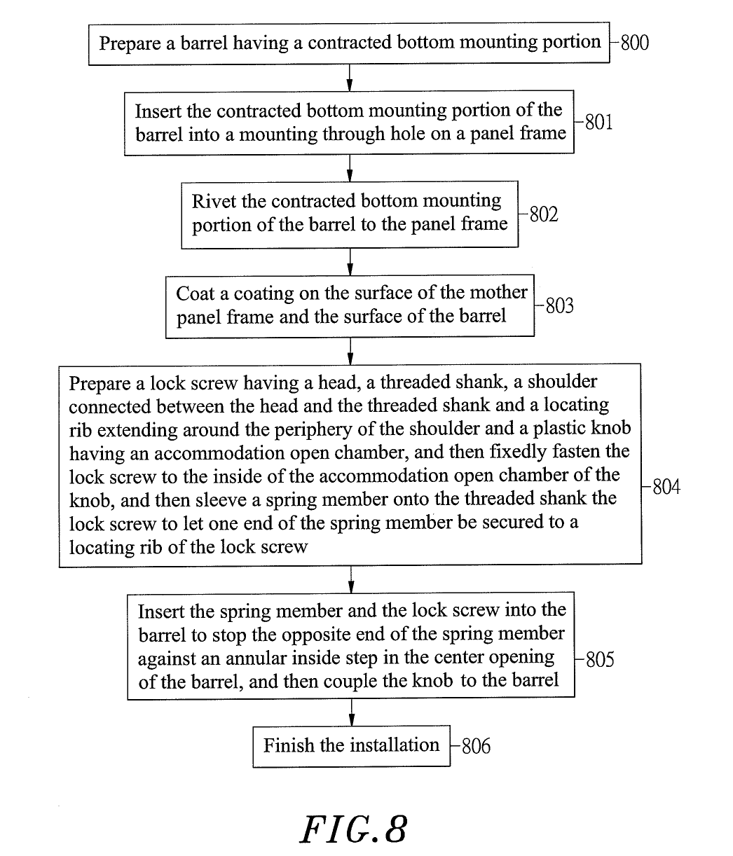

### DETAILED DESCRIPTION OF THE PREFERRED EMBODIMENT

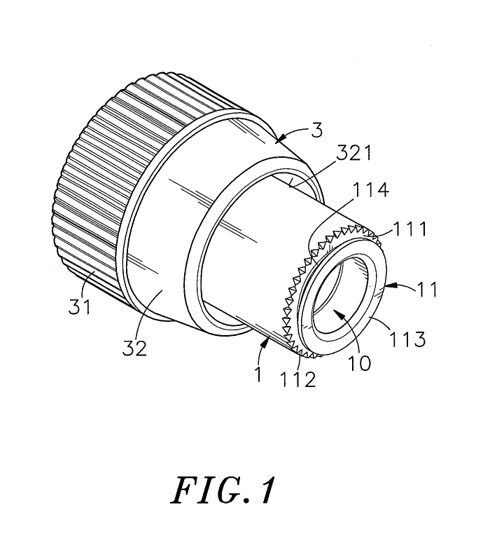

Referring to FIGS. 1˜7, a captive screw in accordance with the present invention comprises a lock screw 2, a barrel 1, a knob 3 and a spring member 4.

The barrel 1 is a hollow cylinder having a center opening 10 extending through top and bottom ends thereof for accommodating the spring member 4 and for the passing of a threaded shank 23 of the lock screw 2, an annular inside step 101 disposed in the center opening 10, a contracted bottom mounting portion 11 axially disposed at the bottom end around the center opening 10, a stop edge 111 transversely disposed at the top side of the contracted bottom mounting portion 11, a series of teeth 112 extending around the stop edge 111, a bottom flange 113 extending around the bottom side of the contracted bottom mounting portion 111, a locating groove 114 extending around the periphery of the contracted bottom mounting portion 11 between the stop edge 111 and the bottom flange 113, and a top coupling flange 12 extending around the periphery of the top end.

The lock screw 2 has a head 21, a shank 23 perpendicularly extended from the center of the bottom wall 212 of the head 21, an outer thread 231 spirally extending around the periphery of the shank 23, a toothed engagement portion 211 located on the periphery of the head 21, a shoulder 22 connected between the bottom wall 212 of the head 21 and the top end of the shank 23, a locating rib 221 extending around the periphery of the shoulder 22 and a tool groove 222 located on the top wall 24 of the head 21.

The knob 3 is a hollow cylindrical plastic member, having an accommodation open chamber 30 axially extending through the top and bottom sides thereof, an inside retaining groove 301 disposed inside the accommodation open chamber 30, an embossed grip 31 extending around the accommodation open chamber 30 at an upper side, a tapered peripheral wall 32 axially downwardly extending from the embossed grip 31 and reducing in diameter gradually in direction away from the embossed grip 31, and a front coupling portion 321 inwardly protruded from the distal end of the tapered peripheral wall 32. The front coupling portion 321 can be formed of an annular flange, or multiple blocks.

The spring member 4 has a coiled body 42 and two end portions 41 at two distal ends of the coiled body 42.

During installation, fasten the contracted bottom mounting portion 11 of the barrel 1 to a mounting through hole 50 of one panel frame 5, and then fasten the toothed engagement portion 211 of the head 21 of the lock screw 2 to the inside retaining groove 301 in the accommodation open chamber 30 of the accommodation open chamber 30 of the knob 3, and then sleeve the spring member 4 onto the shoulder 22 and shank 23 of the lock screw 2, and then insert the spring member 4 and the lock screw 2 into the center opening 10 of the barrel 1 and couple the knob 3 to the barrel 1. At this time, one end portion 41 of the spring member 4 is secured to the locating rib 221 of the lock screw 2, and the other end portion 41 of the spring member 4 is stopped against the annular inside step 101 in the center opening 10 of the barrel 1. When coupling the knob 3 to the barrel 1 after insertion of the spring member 4 and the shank 23 of the lock screw 2 into the center opening 10 of the barrel 1, attach the tapered peripheral wall 32 to the outside wall of the barrel 1, and then press the knob 3 downwards to force the front coupling portion 321 of the knob 3 over the top coupling flange 12 of the barrel 1. The elastically deformable material property of the knob 3 enables the front coupling portion 321 of the knob 3 to be forced over the top coupling flange 12 of the barrel 1. After the front coupling portion 321 of the knob 3 is moved over the top coupling flange 12 of the barrel 1, the front coupling portion 321 immediately returns to its former shape subject to the elastically deformable material property of the knob 3, and then stopped below the top coupling flange 12 of the barrel 1. At this time, the user can press down the knob 3 and the lock screw 2 by hand, and then rotate the knob 3 to thread the outer thread 231 of the lock screw 2 into the mounting screw hole 51 of another metal panel frame 5, thereby locking the two metal panel frames 5 together. Further, a hand tool, for example, screwdriver may be used and attached to the tool groove 241 and rotated to drive the shank 23 of the lock screw 2 through the mounting through hole 50 of one metal panel frame 5 into the mounting screw hole 51 of the other metal panel frame 5 rapidly with less effort.

A captive screw installation method in accordance with the present invention includes the following steps:
(800) Prepare a barrel 1 having a center opening 10 extending through top and bottom ends thereof, an annular inside step 101 disposed in the center opening 10, a contracted bottom mounting portion 11 axially disposed at the bottom end around the center opening 10, a stop edge 111 transversely disposed at the top side of the contracted bottom mounting portion 11 and a locating groove 114 extending around the periphery of the contracted bottom mounting portion 11;
(801) Fasten the contracted bottom mounting portion 11 of the barrel 1 to a mounting through hole 50 of one mother panel frame 5 to stop the stop edge 111 of the contracted bottom mounting portion 11 of the barrel 1 against the top wall of the mother panel frame 5;
(802) Apply a riveting technique to force the series of teeth 112 of the contracted bottom mounting portion 11 of the barrel 1 into the mounting through hole 50 of the mother panel frame 5 and to deform the peripheral wall of the mounting through hole 50 of the mother panel frame 5 and to engage the deformed peripheral wall of the mounting through hole 50 of the mother panel frame 5 into the locating groove 114 around the periphery of the contracted bottom mounting portion 11 of the barrel 1 between the stop edge 111 and a bottom flange 113 of the contracted bottom mounting portion 11 of the barrel 1;
(803) Apply a spray painting technique to coat a coating 6 on the surface of the mother panel frame 5 and the surface of the barrel 1;
(804) Prepare a lock screw 2, which comprises a head 21, a threaded shank 23 perpendicularly extended from the center of the bottom wall 212 of the head 21, a shoulder 22 connected between the bottom wall 212 of the head 21 and the top end of the shank 23 and a locating rib 221 extending around the periphery of the shoulder 22, and a knob 3, which comprises an accommodation open chamber 30 axially extending through the top and bottom sides thereof, an embossed grip 31 surrounding the accommodation open chamber 30, an inside retaining groove 301 disposed inside the accommodation open chamber 30, a tapered peripheral wall 32 axially downwardly extending from the embossed grip 31 and reducing in diameter gradually in direction away from the embossed grip 31 and a front coupling portion 321 inwardly protruded from the distal end of the tapered peripheral wall 32, and then fixedly fasten the head 21 of the lock screw 2 to the inside retaining groove 301 in the accommodation open chamber 30 of the knob 3, and then sleeve a spring member 4 onto the threaded shank 23 and shoulder 22 of the lock screw 2 to let one end of the spring member 4 be secured to the locating rib 221 of the lock screw 2;
(805) Insert the spring member 4 and the lock screw 2 into the center opening 10 of the barrel 1 to stop the other end of the spring member 4 against the annular inside step 101 in the center opening 10 of the barrel 1, and then couple the knob 3 to the barrel 1 by pressing the knob 3 downwards to force the front coupling portion 321 of the knob 3 over the top coupling flange 12 of the barrel 1.
(806) Finish the installation.

According to the present invention, the barrel 1 is riveted to a panel frame 5 at first, and then the lock screw 2, the knob 3 and the spring member 4 are assembled together and then installed in the barrel 1. When riveting the barrel 1 to the panel frame 5, a pressure is applied to the barrel 1 against the panel frame 5 to force the series of teeth 112 of the contracted bottom mounting portion 11 of the barrel 1 into the mounting through hole 50 of the mother panel frame 5 and to deform the peripheral wall of the mounting through hole 50 of the mother panel frame 5 and to engage the deformed peripheral wall of the mounting through hole 50 of the mother panel frame 5 into the locating groove 114 around the periphery of the contracted bottom mounting portion 11 of the barrel 1 between the stop edge 111 and a bottom flange 113 of the contracted bottom mounting portion 11 of the barrel 1.

After installation of the barrel 1 in the panel frame 5, a coating 6 is coated on the surface of the mother panel frame 5 and the surface of the barrel 1 by spray painting. Because the coating 6 is achieved after installation of the barrel 1 in the panel frame 5, the surface of the panel frame 5 has a nice looking after installation of the captive screw. Further, the coating 6 on the surface of the barrel 1 facilitates axial sliding of the front coupling portion 321 of the knob 3 along the periphery of the barrel 1 within the distance between the top coupling flange 12 of the barrel 1 and the top wall of the panel frame 5. Further, because the knob 3 is molded from plastics, the front coupling portion 321 is flexible and deformable and will not damage the coating 6 on the surface of the barrel 1 during installation.

Further, after coating, the coating 6 is rapidly dried by baking. After the coating 6 has been well dried, the lock screw 2, the knob 3 and the spring member 4 are assembled together and then installed in the barrel 1. Because the lock screw 2, the knob 3 and the spring member 4 are assembled together and then installed in the barrel 1 after baking of the coating 6, baking the coating 6 does not damage the lock screw 2, the knob 3 or the spring member 4. Therefore, the invention prevents the spring member 4 from elastic fatigue due to tempering, and also prevents the knob 3 from property deterioration, softening, fading or fusion due to heat. After fastening of the lock screw 2 to the knob 3 and fastening of the spring member 4 to the lock screw 2, insert the spring member 4 and the lock screw 2 into the barrel 1, and then couple the knob 3 to the barrel 1. Because the tapered peripheral wall 32 of the knob 3 is elastically deformable (a plastic material is much more flexible when compared to aluminum that is commonly used in the prior art designs), the front coupling portion 321 of the knob 3 can be forced over the top coupling flange 12 of the barrel 1 directly and manually without any tool means. Thus, the installation of the captive screw is easy, rapid, time-saving and labor-saving.

Further, when coating the barrel 1 and the panel frame 5, it is not necessary to shield the barrel 1. After coating, it is not necessary to remove the barrel 1 from the panel frame 5. Thus, the invention simplifies the installation of the captive screw. Further, the elastically deformable material property of the knob 3 allows the user to remove the knob 3, the lock screw 2 and the spring member 4 from the barrel 1 for a replacement or repair without damaging the coating 6.

Further, a hand tool, for example, screwdriver may be attached to the tool groove 241 on the top wall 24 of the head 21 of the lock screw 2 and rotated to drive the lock screw 2 into the workpiece rapidly with less effort. Further, the tool groove 241 can be configured to fit a flat-tip screwdriver, crossed-tip screwdriver, hex wrench, hex socket wrench or open-ended spanner. Further, the embossed grip 31 of the knob 3 can have an embossed pattern formed of crossed lines, transverse lines, raised portions, and etc. facilitating grasping by hand.

As stated above, the captive screw installation method of the invention is to rivet the barrel 1 of the prepared captive screw to the mounting through hole 50 of a panel frame 5 at first, and then to coat a coating 6 on the surface of the barrel 1 and the surface of the panel frame 5, and then to fasten the lock screw 2 to the accommodation open chamber 30 of the plastic knob 3 and to sleeve the spring member 4 onto the shank 23 of the lock screw 2 and to fasten the spring member 4 to the locating rib 221 of the shoulder 22 of the lock screw 2, and then to insert the lock screw 2 and the spring member 4 into the barrel 1 and then to couple the knob 3 to the barrel 1. This installation method is simple, rapid, time-saving and labor-saving, and facilitates removal of the knob 3, the lock screw 2 and the spring member 4 from the barrel 1 for a replacement or repair. Further, installation of the captive screw does not damage the coating 6.

In actual practice, the captive screw installation method of the present invention has the following advantages and features:
1. The barrel 1 of the prepared captive screw is riveted to the mounting through hole 50 of a panel frame 5 prior to coating of the coating 6 on the surface of the barrel 1 and the surface of the panel frame 5, avoiding damage to the coating 6 during installation of the barrel 1.
2. After installation of the barrel 1 in the panel frame 5, the lock screw 2, the plastic knob 3 and the spring member 4 are assembled and then coupled to the barrel 1, avoiding elastic fatigue of the spring member 4 due to tempering, or property deterioration, softening, fading or fusion of the plastic knob 3 due to heat.
3. The elastically deformable material property of the plastic knob 3 facilitates detachable installation of the plastic knob 3 in the barrel 1 without any tools, and avoids damage to the coating 6 during sliding movement of the knob 3 along the barrel 1.
4. It is not necessary to shield the barrel 1 when coating the barrel 1 and the panel frame 5, or to remove the barrel 1 from the panel frame 5 after the coating operation is done, and therefore the captive screw installation procedure is simplified.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A captive screw installation method, comprising the steps of:
(a) preparing a barrel having a center opening extending through top and bottom ends thereof, an annular inside step disposed in said center opening, a contracted bottom mounting portion axially disposed at the bottom end around said center opening, a stop edge transversely disposed at a top side of said contracted bottom mounting portion, a series of teeth extending around said stop edge and a locating groove extending around the periphery of said contracted bottom mounting portion;
(b) inserting said contracted bottom mounting portion of said barrel into a mounting through hole of a panel frame to stop said stop edge of said contracted bottom mounting portion of said barrel against a top wall of said panel frame;
(c) applying a riveting technique to fasten the series of teeth of said contracted bottom mounting portion of said barrel to the mounting through hole of said panel frame;
(d) applying a spray painting technique to coat a coating on the surface of said panel frame and the surface of said barrel;
(e) preparing a lock screw having a head, a threaded shank, a shoulder connected between the head and the threaded shank and a locating rib extending around the periphery of the shoulder and a plastic knob having an accommodation open chamber, and then fixedly fastening said lock screw to the inside of said accommodation open chamber of said knob, and then sleeving a spring member onto the threaded shank and shoulder of said lock screw to let one end of said spring member be secured to the locating rib of said lock screw;
(f) inserting said spring member and said lock screw into the center opening of said barrel to stop an opposite end of said spring member against the annular inside step in the center opening of said barrel, and then coupling said knob to said barrel; and
(g) finishing the installation.

2. The captive screw installation method as claimed in claim 1, wherein the riveting technique of step (c) is to force the series of teeth of said contracted bottom mounting portion of said barrel into the mounting through hole of said panel frame and to deform the peripheral wall of said mounting through hole of said panel frame and to engage the deformed peripheral wall of said mounting through hole of said panel frame into the locating groove around the periphery of said contracted bottom mounting portion of said barrel between said stop edge and said bottom flange of said contracted bottom mounting portion of said barrel.

3. The captive screw installation method as claimed in claim 2, wherein said lock screw further comprises a toothed engagement portion located on the periphery of said head; said knob further comprises an inside retaining groove disposed inside said accommodation open chamber; said lock screw is fastened to said knob during step (e) by: fixedly fastening the toothed engagement portion of said head of said lock screw to the inside retaining groove in said accommodation open chamber of said knob.

4. The captive screw installation method as claimed in claim 1, wherein said knob further comprises an embossed grip extending around said accommodation open chamber, a tapered peripheral wall axially downwardly extending from said embossed grip and reducing in diameter gradually in direction away from said embossed grip and a front coupling portion inwardly protruded from the distal end of said tapered peripheral wall; said knob is coupled to said barrel during step (f) by: pressing said knob downwards to force said front coupling portion of said knob over the top coupling flange of said barrel.
